(19) United States
(12) Patent Application Publication
(10) Pub. No.: US 2022/0228899 A1
(43) Pub. Date: Jul. 21, 2022

(54) EXTRUDED FLUID SENSOR FOR IMPEDANCE-BASED ACQUISITION OF A QUANTITY OR A QUALITY OF A FLUID SURROUNDING THE SENSOR

(71) Applicant: Röchling Automotive SE & Co. KG, Mannheim (DE)

(72) Inventors: Stefano Dalpez, Malè (TN) (IT); Elia Mulas, Cavedine (TN) (IT); Fabrizio Chini, Isera (TN) (IT); Davide Monsorno, Trento (IT); Matteo Traina, Tenno (TN) (IT); Saverio Girardi, Trento (IT)

(21) Appl. No.: 17/577,165

(22) Filed: Jan. 17, 2022

(30) Foreign Application Priority Data
Jan. 19, 2021 (DE) 10 2021 101 055.1

(51) Int. Cl. G01F 23/24; G01N 27/06

(52) U.S. Cl. CPC G01F 23/24; G01N 27/06

(57) ABSTRACT

A fluid sensor for impedance-based determination of a quantity or a quality, such as type, composition, or purity of a fluid present in the surroundings of the fluid sensor, where the fluid sensor includes a first electrically conductive electrode which is arranged on a first extruded substrate component made of an electrically insulating, thermally curable synthetic, and where the fluid sensor includes a second electrically conductive electrode which is arranged on a second extruded substrate component made of an electrically insulating, thermally curable synthetic, where in each case an electrically conductive surface both that of the first electrode and also of the second electrode is exposed in such a way that it is wettable by fluid in the surroundings of the fluid sensor.

This application claims priority in German Patent Application DE 10 2021 101 055.1 filed on Jan. 19, 2021, which is incorporated by reference herein.

The present invention concerns a fluid sensor for determining a quantity or a quality, such as type, composition, or purity, of a fluid present in the surroundings of the sensor, where the fluid sensor comprises a first electrically conductive electrode arranged on a first extruded substrate component made of an electrically insulating, thermally curable synthetic, and where the fluid sensor comprises a second electrically conductive electrode arranged on a second extruded substrate component made of an electrically insulating, thermally curable synthetic.

### BACKGROUND OF THE INVENTION

A capacitive fuel level sensor is known from WO 2011/084940 A2, comprising a substrate component and two flat material strips arranged next to one another and in parallel on a common plane surface of the substrate component. The two material strips are formed by extrusion and constitute field electrodes of the known capacitive fuel level sensor. The substrate component is formed of dielectric material. The whole sensor arrangement of the capacitive fuel level sensor is surrounded by a casing, which protects the material strips and the substrate component against direct contact with the fuel.

The known capacitive fuel level sensor preferably penetrates in the shape of a helix through the accommodating volume of a fuel tank from the tank's top to the tank's bottom. Together with a tank-filled fuel which acts as a dielectric, the known capacitive fuel sensor forms a capacitor whose dielectric constant during operation of the known fuel sensor which depends on the fuel level filled in the tank is ascertained and from it the fuel filling quantity accommodated in the tank that is associated with the ascertained dielectric constant is determined.

The known tank exhibits, in addition to the known capacitive fuel level sensor, a capacitive reference sensor. In contrast to the fuel level sensor, of which always at least one section is not immersed in fuel when the fuel tank is only partly filled, the reference sensor with both its field electrodes is situated in the region of the tank's bottom and nearly independently of the filling level of the fuel tank is permanently surrounded completely by fuel. Therefore, a reference signal can be obtained from the capacitive reference sensor which given a known shape of the reference sensor allows calibration of the fuel level sensor in terms of the fuel currently filled in the tank.

### SUMMARY OF THE INVENTION

The known capacitive fuel level sensor is costly to manufacture. It is, therefore, the task of the present invention to propose a fluid sensor which for the same reliability is simpler to manufacture.

The present invention solves this task by means of a fluid sensor for impedance-based determination of a quantity or a quality, such a type, composition, or purity of a fluid present in the surroundings of the sensor, where the fluid sensor comprises a first electrically conductive electrode which is arranged on a first extruded substrate component made of an electrically insulating, thermally curable synthetic, and where the fluid sensor comprises a second electrically conductive electrode which is arranged on a second extruded substrate component made of an electrically insulating, thermally curable synthetic, where in each case an electrically conductive surface both that of the first electrode and also of the second electrode is exposed in such a way that it is wettable by the fluid in the surroundings of the fluid sensor.

Due to the impedance-based determination of the quantity or the quality of a fluid surrounding the fluid sensor, it is required that during the operation of the fluid sensor a current can flow between the first and the second electrode through the fluid wetting both electrodes. Therefore, each of the electrically conductive electrodes exhibits at least one electrically conductive surface which is exposed to the surroundings of the electrode. As a consequence, a fluid accommodated in the surroundings of the electrode can wet the surface and hence the electrode such that a current can flow between the electrode and the fluid.

Consequently, the covering of the capacitive level sensor known from the state of the art is no longer required in the present impedance-based level sensor.

The simplified construction and with it the simplified manufacturing of the impedance-based fluid sensor compared with the known capacitive fuel level sensor necessitates certain limitations to which the known capacitive fuel level sensor is not subjected. To wit, so that a current can flow between the two electrodes of the impedance-based fluid sensor, the fluid in the surroundings of the fluid sensor has to be in some way electrically conductive. Electric conductance of a fluid can, for example, be provided by an ion content of the fluid or by a polarity of at least some part of its molecules. Thus water, even when it is completely demineralized, due to the polarity of its molecules and the resulting known ability to form hydrogen bridges can ensure adequate current flow between the electrodes. Fuel, which normally is neither ion-containing nor polar, cannot be measured with regard to its quantity or quality with the impedance-based fluid sensor proposed here.

The fluid sensor proposed here is envisaged in particular for use in a vehicle in which numerous other sufficiently conductive fluids, in particular liquids, are provided, where a measurement of their level in a reservoir by the proposed fluid sensor is of interest. Thus for example, washing liquid such as wiper fluid for cleaning vehicle windshields, cooling liquid for dissipating heat from an internal combustion engine, or aqueous urea solution for the reduction of nitrogen oxides in the exhaust gas, and the like can be measured in their respective reservoir by the proposed fluid sensor as regards quantity and/or quality.

By means of the extrusion, a substrate component of arbitrary length can be manufactured simply and cost-effectively. Preferably, based on the subsequent usage length of the fluid sensor, an over-long first and second substrate component are extruded and afterwards cut to length as needed.

An especially efficient first and/or second electrode, since it exhibits high electric conductance, can be formed by a metal strip, preferably made of stainless steel for instance because of its chemical stability.

Especially easily, a metal strip can be arranged with its longitudinal direction parallel to the extrusion axis and/or extrusion direction respectively that always forms at an extruded component. Therefore, according to a first preferred embodiment of the present invention, the first and/or the second electrode is formed from a metal strip proceeding along the extrusion direction of the substrate component carrying it.

In principle, the metal strip can be glued on its associated substrate component or in some other way bonded with it adhesively. More simply and thus more cost-effectively, the affixing of the metal strip onto its associated substrate component can take place in such a way that the first and/or the second electrode is fed as a metal strip parallel to the associated substrate component during the latter's extrusion and bonded with the still soft or still not completely cured substrate component. To this end, besides the extrusion nozzle out of which the substrate component is extruded in the extrusion direction, there can be provided an aperture out of which the metal strip is dispensed from an appropriate reservoir, for instance a roll, and applied onto the substrate component which pushes itself at the extrusion speed out of the extrusion nozzle. The feeding speed of the metal strip preferably corresponds to the extrusion speed of the substrate component, such that the metal strip can be applied slippage-free onto its substrate component.

Preferably, the thermally curing material of the substrate component is a thermoplastic synthetic, in particular a thermoplastic polyolefin. It should, however, not be precluded that the thermally curing material of the substrate component is initially a paste-like material whose cross-linking or other curing reaction is triggered or effected by changing its temperature and that once curing has taken place, cannot be thermally re-softened.

An electrode which exhibits lower electric conductance than the previously described metal strip but can be made in a greater variety of cross-sectional shapes, can be formed from a thermally curing material filled with electrically conductive material. Once again, this thermally curing material can be a thermoplastic synthetic, which is preferable, or it can be, as described above, a polymer cross-linking once only through a temperature change.

Therefore the first and/or the second electrode, like the substrate component carrying them, can be formed by extrusion. Since independently of the manner of their manufacturing, the first and/or the second electrode preferably exhibit along their longitudinal extension a constant cross-sectional shape with a constant cross-sectional area, such that their electric properties are constant along their longitudinal extension.

The first and/or the second electrode can therefore be formed from a material strip of a thermally curing material, in particular thermoplastic synthetic, filled with electrically conductive material, coextruded together with the substrate component carrying them and therefore proceeding along the extrusion direction of the substrate component carrying them. Consequently, the first and/or the second electrode and the first and/or second substrate component respectively carrying them can be produced and bonded with one another in a single coextrusion process step.

The advantage of using thermoplastic synthetics lies in the fact that after curing they can be re-melted again, such that a component formed from a thermoplastic synthetic can be thermally joined, in particular welded, with a component formed from a compatible synthetic.

If the extruded electrode does not already exhibit an electrically conducting surface, which given a sufficiently high filling degree of a thermoplastic synthetic with electrically conductive particles is normally the case by itself after extrusion, at least one surface can be ground as needed in order to expose electrically conductive particles at the surface.

From DE 10 2006 005 529 A1 there is known a synthetic tank for a vehicle, whose tank wall discloses two injection-molded electrodes extending in parallel as a level sensor or, rotated by 90°, also as a fluid quality sensor. The electrodes are manufactured from a thermoplastic synthetic filled with electrically conductive particles.

In contrast to the known injection-molded electrodes, due to the considerably reduced extrusion speed compared with the flow speed in injection molding the extruded electrodes proposed above can exhibit a higher filling degree of electrically conductive particles. An extruded, in particular coextruded electrode exhibits preferably between 40% by weight and 70% by weight electrically conducting filling material. With the higher filling degree of electrically conductive particles, there is ensured higher electric conductance of the component achieved thereby.

In principle, the material of the electrodes can also be filled with electrically conducting fibers. A filling of electrically conductive powder, however, is preferred for reasons of the most homogeneous electric conductance possible in the volume of the extruded electrode. Preferably, the thermally curing material of the first and/or of the second electrode is filled with graphite powder. Graphite powder is cost-effective, can be well processed, in particular mixed well and homogenously into a softened synthetic mass, and is available in the marketplace without problems. Especially preferably, the material of the first and/or of the second electrode is filled only with a powder and comprises no electrically conductive fibers as filling material.

In order to be able to produce current flow sufficient for measuring the fluid quantity or the fluid quality in fluids with little electric conductance also, it is advantageous if the first and the second electrode are arranged with wettable electrically conductive surfaces facing towards one another.

Preferably, the electrically conductive surface is the largest surface of the electrode exposed to the surroundings of the electrode. Especially preferably, all of the surfaces exposed to the surroundings of the electrode are electrically conductive.

In principle it should not be precluded that the wettable conductive surfaces of the first and/or of the second electrode exhibit a surface shape which provides a quantitatively especially large surface in a comparatively small space. For example, it can be envisaged that the first and/or the second electrode is a profiled electrode with a profiled electrically conductive wettable surface. When considering a sectional plane orthogonal to the extrusion direction, the electrode can exhibit a comb-like cross-sectional surface with a base from which a plurality of projections protrude, whose wettable boundary areas are electrically conductive and together form the electrically conductive surface. In order to achieve the most homogenous current flow conditions possible along the electrodes, however, it is preferable that the two wettable electrically conductive surfaces of the first and the second electrode facing towards one another are at least section-wise, preferably completely, parallel to one another.

In principle, it can be envisaged to have the first and the second substrate component formed separately from one another and arranged in a fluid tank. For example, each substrate component can be attached by itself to a tank wall, in particular tank side—wand. For example, a substrate component formed from a thermoplastic synthetic can be welded with a tank wall formed from a compatible synthetic, for instance by infrared, ultrasound, mirror, or laser welding. A preferred unambiguous spatial arrangement of the first and of the second electrode, in particular of their wettable electrically conductive surfaces, relative to one another can be obtained by having the first and the second substrate component as different sections of an integrally formed extruded substrate arrangement. For example, the substrate arrangement can be an extruded bar material with two flanks parallel to one another, where each flank forms one substrate component respectively. The bar material can exhibit a U cross-section or a double-T cross-section in a sectional plane orthogonal to the extrusion direction. The two flanks as substrate components are connected with one another by a further section of the substrate component. As substrate components, each of two flanks carries one electrode respectively.

Since preferably the first and the second electrode, in particular their wettable electrically conductive surfaces, are aligned parallel to one another, this preferred alignment can be achieved simply and effectively by having the flanks of the substrate arrangement parallel to one another at least section-wise, preferably completely, and are connected with one another by a base section of the substrate arrangement.

The use of a thermoplastic synthetic filled with electrically conductive material, in particular powder material, to form an electrically conductive electrode has the additional technical advantage that a connector component for connecting the electrically conductive electrode to an electrical conductor can be arranged at an electrode formed in this way with little cost. For example, an electrically conducting connector component, in particular made of metal, can be inserted into such an electrode, i.e. for example pushed in, pressed in, or driven in rotationally, in particular screwed in. Consequently, the fluid sensor can exhibit an electrically conducting connector component pressed or screwed into the thermoplastic synthetic filled with electrically conductive material. The connector component can exhibit in its anchor section inserted into the electrically conductive synthetic of the electrode a pull-out protection which prevents pulling of the connector component out of the electrode. In a screwed-in connector component this pull-out protection can be the thread, or in a translationally inserted connector component it can be a sawtooth contour or a Christmas tree profile. Preferably, the anchor section with its pull-out protection secures the connector component by positive locking against pulling out of the electrode.

Preferably the connector component is inserted in a mounting surface which is oriented transversely, in particular orthogonally, to the extrusion direction.

The fluid sensor described above can be pre-assembled with further components into a fluid sensor arrangement. Such a fluid sensor arrangement preferably exhibits a sensor carrier which carries a fluid sensor configured as a fluid level sensor and/or which carries a fluid sensor configured as fluid quality sensor. Both the fluid level sensor and the fluid quality sensor are preferably configured as described above. The fluid quality sensor is preferably formed from the same extrusion material as the fluid level sensor and merely exhibits a shorter length in the extrusion direction. Preferably the fluid level sensor is at least 5 times, especially preferably at least 8 times, even more preferably at least 10 times as long as the fluid quality sensor. Whereas in the case of the fluid level sensor it is intended that the length, to be measured in the extrusion direction, of its section that is wetted by a liquid surrounding it depends on the filling degree of the container at which the fluid level sensor is deployed, the fluid quality sensor is preferably dimensioned in such a way that as far as possible regardless of the filling degree of the container it is permanently immersed completely in the liquid surrounding it. The sensor carrier can form part of a tank wall, preferably of a tank bottom, of a tank in which the fluid sensor arrangement is arranged. The fluid sensor arrangement can be inserted through an aperture in the tank's wall and the aperture can be closed off with the sensor carrier.

At the sensor carrier there can be arranged an electric or electronic switching circuit module for inducing a temporally varying current in an electrode of a fluid sensor and/or for measuring a temporally varying current in the other electrode respectively of the fluid sensor. For impedance-based determination of the quantity or of the quality of a fluid, at least one of the two electrodes is supplied with a temporally varying current, for example with a rectangular, sinusoidal, or sawtooth time pattern in the current course. Preferably, the current induced in at least one of the two electrodes is periodically time-variable.

Together with the fluid sensor described above, there was also described its manufacturing method which comprises the following steps:
Extrusion of a thermally curable synthetic as a substrate component,
Simultaneous feeding of an electrically conductive electrode to the extruded substrate component, and
Bonding of the substrate component and the electrode with one another.

Advantageous further development of this method are already described above in connection with the description of the fluid sensor itself.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1 A tank in schematic part cross-section with a fluid sensor arrangement with a fluid sensor according to the invention when viewed in the direction of the arrow I of FIG. 2,

FIG. 2 The tank of FIG. 1 in schematic part cross-section when viewed in the direction of the arrow II of FIG. 1,

FIG. 3 A schematic perspective view of the fluid sensor arrangement of FIGS. 1 and 2,

FIG. 4A A rough schematic front view of a connector component pushed into an extruded electrode, and

FIG. 4B A rough schematic side view of the connector component of FIG. 4A pushed into an extruded electrode.

### DESCRIPTION OF PREFERRED EMBODIMENTS

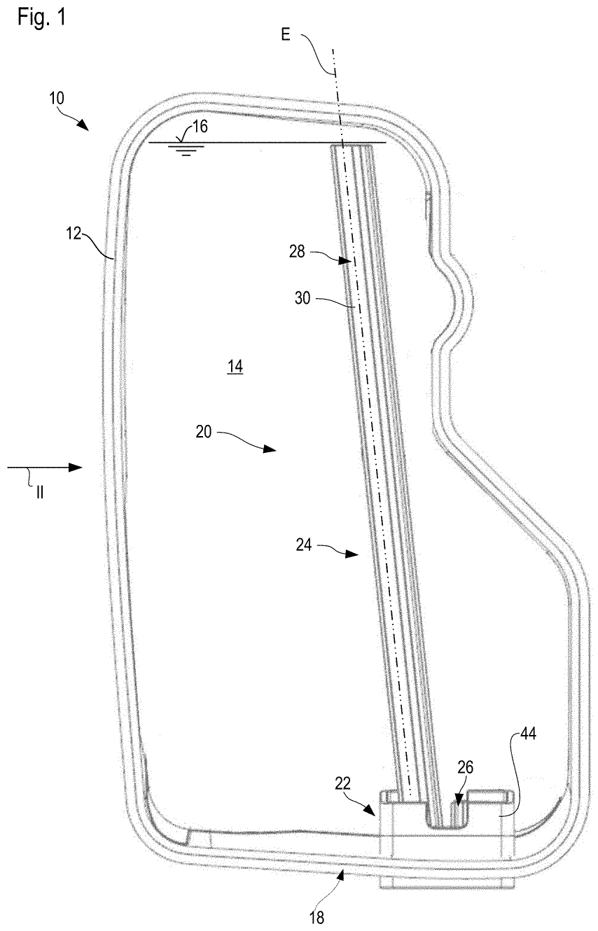

Referring now to the drawings wherein the showings are for the purpose of illustrating preferred and alternative embodiments of the invention only and not for the purpose of limiting the same, in FIG. 1, a liquid tank for accommodating an operating fluid on a vehicle is denoted generally by 10. The tank 10 exhibits a tank wall 12 which confines a tank volume 14 inside the tank 10 towards the outside.

The tank 10 can be blow-molded from a thermoplastic synthetic or it can be joined together from several injection-molded tank shells. In the latter case too, the tank wall 12 is formed from a thermoplastic synthetic.

A line 16 in FIG. 1 indicates the maximum filling height up to which liquid can be accommodated in the tank volume 14 of the tank 10.

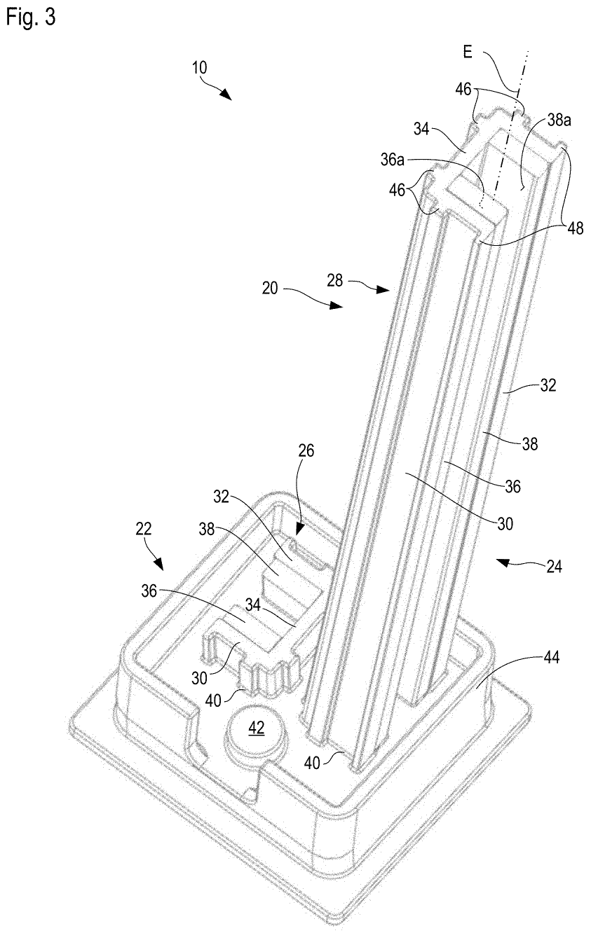

At the tank wall 12, more precisely at the tank bottom 18, there is accommodated a fluid sensor arrangement 20, with a sensor carrier 22 which carries a fluid level sensor 24 and a fluid quality sensor 26 which is more clearly discernible in FIG. 3.

The fluid level sensor 24 extends from the sensor carrier 22 up to approximately the maximum filling height indicated by the line 16, such that the length of the fluid level sensor 24 wetted by the liquid accommodated in the tank volume 14 corresponds approximately for all filling quantities properly accommodated in the tank 10 to the respective current filling height of the liquid in the tank volume 14 or is a linear-proportional function of same.

The fluid quality sensor 26 is constructed identically to the fluid level sensor 24. Merely the extension length of the fluid quality sensor 26 along the extrusion axis E of the fluid sensors 24 and 26 is significantly shorter in the fluid quality sensor 26 than in the fluid level sensor 24. The fluid quality sensor 26 protrudes for a short distance from the sensor carrier 22 in such a way that other than in the case of complete emptying of the tank 10, for most liquid quantities accommodated in the tank volume 14 the fluid quality sensor 26 is completely immersed in the respectively accommodated liquid quantity.

From each of the fluid sensors 24 and 26 there is emitted a signal that depends on the impedance of the respective fluid sensor and on the liquid wetting it. Since the wetting situation of the fluid level sensor 24 depends on the level of the liquid quantity 14 filled in the tank 10, the fluid level sensor 24 emits a signal that depends on the level in the tank 10.

Since in the great majority of cases in which liquid is accommodated in the tank volume 14 of the tank 10, the fluid quality sensor 26 is completely wetted by the accommodated liquid, the fluid quality sensor 26 emits, as long as a minimum quantity of liquid is accommodated in the tank 10, an acquisition signal which depends only on the accommodated liquid itself, for instance on its electric conductance. Therefore, the signal of the fluid quality sensor 26 can be used to determine the purity and/or the type and/or the composition of the liquid accommodated in the tank 10, for instance by comparing the signal emitted by the fluid quality sensor 26 with reference signals which are stored in a data memory of a control device, for example in a control device 27, and to which there is matched there corresponding information through previous calibration.

With the quality information obtained through the signals of the fluid quality sensor 26, it can not only possible to determine whether the tank is filled with operating fluid intended for storage by the tank or whether there is erroneous filling, but also whether the filled correct operating fluid is sufficient clean and free from undesirable contamination. The signals of the fluid quality sensor 26 can, furthermore, be utilized for increasing the accuracy of the filling level measurement by the fluid level sensor 24, whose signals in addition to the filling height of the liquid in the tank volume 14 also depend on the quality of the filled liquid.

The fluid sensors 24 and 26 are coextruded as bar material, namely along the extrusion axis E. During the coextrusion of the electrodes 36 and 38 and of the substrate arrangement 28, the extruded bar material leaves the extrusion matrix along the extrusion axis E as a quasi-endless material. After the extrusion, the bar material is cut to the required individual lengths for the fluid sensors 24 and 26.

Since the fluid sensors 24 and 26 are formed from the same extruded bar material, there suffices hereinafter the description of only one fluid sensor, which also applies to the other fluid sensor. Because of the easier recognizability, hereinafter the larger fluid level sensor 24 shall be described in further detail.

In the view shown in FIG. 1, one looks sideways at the substrate arrangement 28 of the fluid level sensor 24.

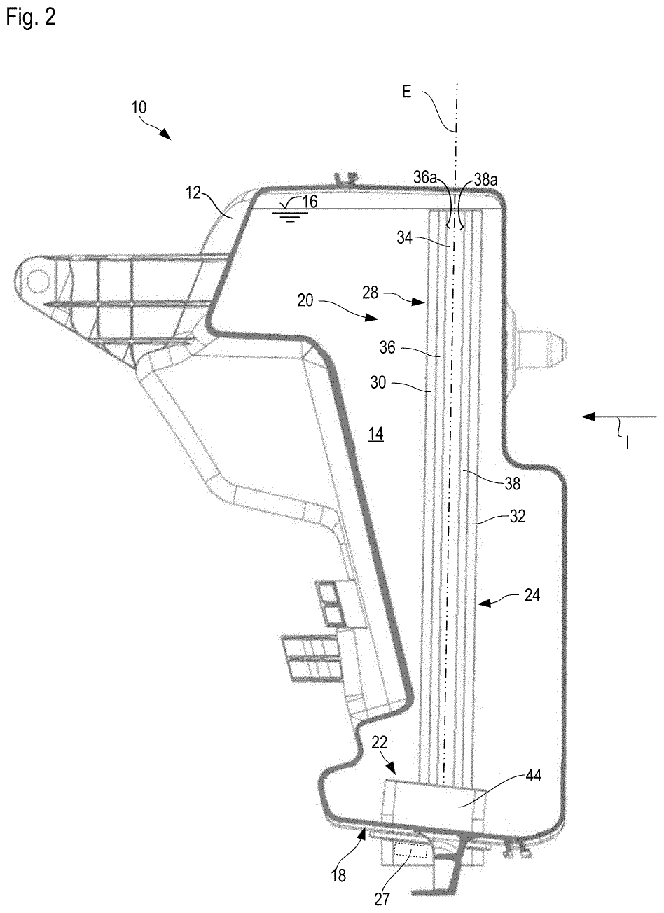

The direction of view towards the tank 10 is rotated by approximately 90° in FIG. 2. One is looking not sideways at the U-shaped substrate arrangement 28 of the fluid sensor 24, but rather one is looking parallel to the flanks 30 and 32 towards the base section 34 of the substrate arrangement 28 which connects the flanks 30 and 32.

On the sides facing towards each other of the flanks 30 and 32, which are substrate components in accordance with the above descriptive introduction, there is arranged on each an electrically conductive electrode 36 or 38 respectively with electrically conductive exposed surfaces 36a and 38a through coextrusion with the substrate arrangement 28.

The substrate arrangement 28 and the electrodes 36 and 38 comprise the same thermoplastic synthetic, for example polypropylene, such that when extruded together they can be firmly bonded with one another without problems. In the present embodiment example, the synthetic of the electrodes 36 and 38 is preferably filled with graphite powder, namely with a quantity fraction of 40% to 60% by weight.

FIG. 3 depicts the fluid sensor arrangement 20 in a schematic perspective view of improved depth of detail compared with FIGS. 1 and 2. Since, as already explained above, the fluid sensors 24 and 26 are formed starting from the same extruded bar material, identical sections of the extruded bar material of the fluid quality sensor 26 are provided with the same reference labels as the already elucidated sections of the exposed bar material of the fluid level sensor 24.

The fluid sensors 24 and 26 are inserted into the sensor carrier 22 in recesses which exhibit a complementary contour to the fluid sensors 24 and 26. The fluid sensors 24 and 26 are preferably firmly bonded with the sensor carrier 22, for instance by gluing or welding. The gap formed between the fluid sensors 24 and 26 and the recesses in the sensor carrier 22 can be sealed with a sealant 40. The course of the sealant 40 shows the course of the gap formed between the fluid sensors 24 and 26 on the one hand and the recesses in the sensor carrier 22 accommodating them on the other. The fluid sensors 24 and 26 completely penetrate through the sensor carrier 22 in the thickness direction, such that the electrodes 36 and 38 are accessible from outside the tank 10.

At the sensor carrier 22 there is arranged on the side facing towards the tank volume, towards which the viewer of FIG. 3 looks, a temperature sensor 42 which measures the temperature of the operating fluid accommodated in the tank volume 14 and relays it to a control device.

The sensor carrier 22 exhibits an overlap surface 44, which overlaps fluid-tight with the tank wall 12 in the fully assembled state of the tank with an intermediate arrangement of a seal or of fluidically applied and then cured sealing material.

The arrangement region of the fluid sensors 24 and 26 and of the temperature sensor 42 is bordered by a collar 44 projecting into the tank volume 14.

In order to stiffen the fluid sensors 24 and 26, in particular the longer fluid level sensor 24, stiffening ribs 46 and 48 are configured at the outer surfaces of the substrate arrangement 28 not occupied by electrodes. The stiffening ribs 46 and the marginal stiffening ribs 48 at the free longitudinal end of the parallel flanks 30 and 32 of the U-shaped substrate arrangement 28 are produced integrally with the rest of the substrate arrangement during extrusion.

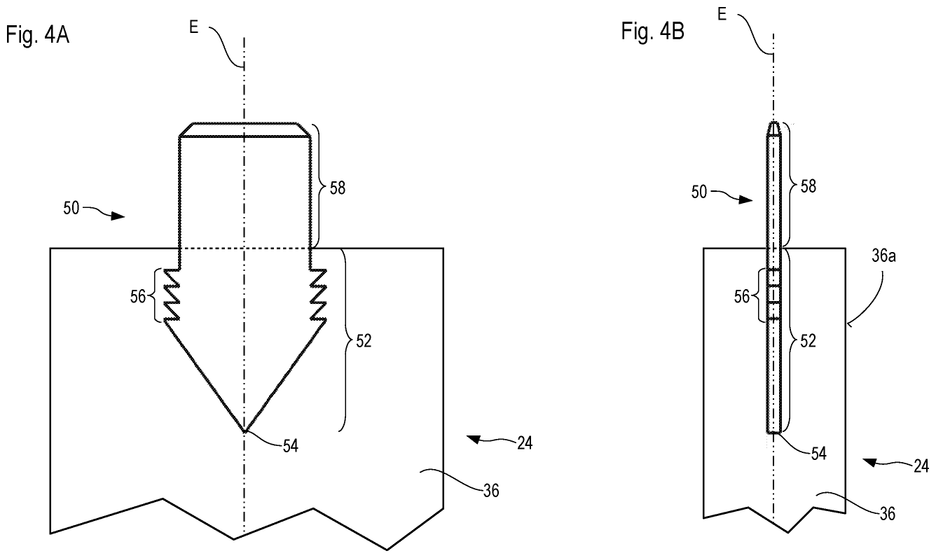

FIGS. 4A and 4B show a connector component 50, whose anchor section 52 is pushed into the electrodes 36 and 38, in the depicted example into the electrode 36.

The anchor section 52 exhibits a tip 54, which due to its wedge action facilitates the pushing of the anchor section 52 into the electrode 36. Sawtooth formations 56 on both sides of the essentially even anchor section 52 and overall even connector component 50 serve as pull-out protection against pulling the connector component 50 out of the electrode 36.

Outside the electrode 36 there remains a connector section 58 to which an electrical conductor can be connected, for instance by soldering or by pushing on a contact shoe.

FIG. 4B shows that the connector component 50 depicted as an example is a flat connector component, i.e. it exhibits a significantly smaller thickness dimension than a length and width dimension.

Instead of a pushed-in or pressed-in connector component, a connector component can also be driven rotationally into, in particular screwed into, an electrode.

In the sensor carrier 22 there can be accommodated the aforementioned control device 27 (s. FIG. 2), which corresponds to the electronic switching circuit module mentioned in the descriptive introduction. It can be connected with the electrodes 36 and 38 so as to allow signal transmission and feed a current into one of the two electrodes and/or acquire and process a current signal from at least one of the two electrodes or relay it to a higher-level control device.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-15. (canceled)

16. A fluid sensor for impedance-based determination of a quantity or a quality, such as type, composition, or purity, of a fluid present in the surroundings of the fluid sensor, where the fluid sensor comprises a first electrically conductive electrode which is arranged on a first extruded substrate component made of an electrically insulating, thermally curable synthetic, and where the fluid sensor comprises a second electrically conductive electrode, which is arranged on a second extruded substrate component made of an electrically insulating, thermally curable synthetic, where in each case an electrically conductive surface both that of the first electrode and also of the second electrode is exposed in such a way that it is wettable by fluid in the surroundings of the fluid sensor.

17. The fluid sensor according to claim 16, wherein the first and/or the second electrode are formed from a metal strip proceeding along an extrusion direction of the substrate component carrying them.

18. The fluid sensor according to claim 16, wherein the first and/or the second electrode are formed from a material strip made of a thermoplastic synthetic filled with electrically conductive material that is coextruded together with the substrate component carrying them and therefore that is proceeding along an extrusion direction of the substrate component carrying them.

19. The fluid sensor according to claim 18, wherein the at least one coextruded electrode exhibits between 40% by weight and 70% by weight electrically conducting filling material.

20. The fluid sensor according to claim 19, wherein the electrically conductive filling material comprises or is an electrically conductive powder.

21. The fluid sensor according to claim 18, wherein the electrically conductive filling material comprises or is an electrically conductive powder.

22. The fluid sensor according to claim 21, wherein the electrically conductive filling material comprises a graphite powder.

23. The fluid sensor according to claim 16, wherein the first and the second electrode are arranged with wettable electrically conductive surfaces facing towards one another.

24. The fluid sensor according to claim 23, wherein the two wettable electrically conductive surfaces facing towards one another of the first and the second electrode are parallel to one another.

25. The fluid sensor according to claim 16, wherein the first and the second substrate component are different sections of an integrally extruded substrate arrangement.

26. The fluid sensor according to claim 25, wherein the substrate arrangement, when viewing a sectional plane orthogonal to an extrusion direction, exhibits two flanks connected with one another, of which each carries one electrode, respectively.

27. The fluid sensor according to claim 26, wherein the flanks of the substrate arrangement at least section-wise are parallel to one another and are connected to one another by a base section of the substrate arrangement.

28. The fluid sensor according to claim 18, wherein the fluid sensor exhibits an electrically conducting connector component pushed into, pressed into, or screwed into the thermoplastic synthetic filled with electrically conductive material.

29. A fluid sensor arrangement with a sensor carrier which carries a fluid sensor according to claim 16 configured as a fluid level sensor and/or a fluid quality sensor.

30. The fluid sensor arrangement according to claim 29, wherein the sensor carrier includes an electric or electronic switching circuit module for inducing a temporally varying current in an electrode of a fluid sensor and/or for measuring a temporally varying current in the other electrode respectively of the fluid sensor.

31. A method for manufacturing a fluid sensor according to claim 16, comprising the following steps:
Extrusion of a thermally curable synthetic as a substrate component,
Simultaneous feeding of an electrically conductive electrode to the extruded substrate component, and
Bonding of the substrate component and the electrode with one another.

32. The method according to claim 31, wherein the step of the simultaneous feeding of the electrically conductive electrode comprises:
Feeding a metal tape from a metal tape reservoir, where the feeding speed corresponds to the extrusion speed,
or
Coextruding a thermally curable synthetic filled with electrically conductive filling material as the electrically conductive electrode together with the extrusion of the substrate component.
